(19) United States
(12) Patent Application Publication
(10) Pub. No.: US 2013/0152681 A1
(43) Pub. Date: Jun. 20, 2013

(54) SENSOR FOR TAUT WIRE FENCES

(71) Applicants: Yehonatan Ben-Hamozeg, Rosh Ha'Ayin (IL); Avraham Saar, Holon (IL); Avi Shaham, Herzliya (IL)

(72) Inventors: Yehonatan Ben-Hamozeg, Rosh Ha'Ayin (IL); Avraham Saar, Holon (IL); Avi Shaham, Herzliya (IL)

(73) Assignee: MAGAL SECURITY SYSTEMS LTD., Yahud (IL)

(21) Appl. No.: 13/817,688

(22) PCT Filed: Aug. 16, 2011
(86) PCT No.: PCT/IL2011/000665

§ 371 Date: Feb. 19, 2013

(30) Foreign Application Priority Data
Aug. 19, 2010 (IL) 207723

(51) Int. Cl. G08B 13/02

(52) U.S. Cl. CPC G08B 13/02
USPC 73/493

(57) ABSTRACT

A sensor for an intrusion detection fence of a taut wires type and a method implemented in its operation, wherein the sensor is a tri-axes accelerometer that is installed on the sensors' pole of the fence while inclined relative to the fence taut wire unto which it is connected, and the sensor is connected to fence taut wire via a movement converting means such that from an instance of biasing the taut wire as happens when an intrusion attempt through it occurs, the movement converting means converts the movement of the taut wire unto a rotational movement of the sensor that is amenable to be sensed in all of its three axes.

### FIELD OF THE INVENTION

The present invention, the subject matter of this application, is found in the field of sensors for intrusion detection fences in general, and focuses on fences that are of the taut wire genre—in particular.

### BACKGROUND OF THE INVENTION

Intrusion detection fences of the type known as “taut wire warning fence” are already known. A typical sector of a taut wire fence includes a couple of anchoring poles, wherein the distance (i.e., space) between them delineates a sector of the fence. Between each of such couple of anchoring poles the wires of the fence (that might be—but not necessarily—of the barbed wire type) are taut. They are at a distance (vertically) one from the other, thus forming a kind of a surface or a plane, defining an area of parallel horizontal wires that is perpendicular to the ground.

The wires that are taut, as said, between given couples of anchoring poles, form a kind of transmission (or communication) lines that provides indications of the occurrence of an intrusion incident (or an attempted one) through them. A change in the tension in a wire of the fence—such as happens while bending or severing the taut wire, that would happen as a result of an intrusion attempt or action (for example climbing on the wires, trying to push away parallel adjacent wires in order to increase the distance between them to enable passage or using cutters on them to cut the wires), any such occurrence is “transmitted” as an amenable to be sensed indication through the usually taut wire, like a (musical) “string”.

The amenable to be sensed indication, as an outcome of the change that occurred in the tension of the wire—is received (sensed) by one sensor or more, that is linked to the taut wire. The sensor, in due course, generates (produces) an electrical signal, that can be received and analyzed at a remote control center.

An example for such intrusion detection fence of the taut wire fence type, is the commercially available and marketed fence, denoted DTR—that is manufactured and marketed by the applicant of this present patent (check their site—http://www.magal-s3.com/products/?did=24&pid=44).

A typical sector of a DTR fence includes plurality of barbed wire cords that are deployed with a distance of nine (9) to twenty (20) cm one from the other, wherein they are taut between a couple of anchoring poles that are located at a typical distance of approximately fifty (50) meters one from the other. A number of sensors are installed on “a sensors' pole” that is positioned approximately at the half point distance located between the two anchoring poles.

In addition, between every two (couple of) anchoring poles, there might be located also one or more “sliding poles”, e.g. —spiral like poles, that enable horizontal movement of the wires on them but at the same time and in all that is concerned with biasing the wires for bending, the sliding poles define and delineate relatively small support spaces, in a manner that forces increasing the effort that have to be exerted for bending the wires, and naturally, in a manner that increases the amenable to be sensed variation of the tensions in the bent wire.

In a DTR fence, each couple of taut wires is allocated to one sensor and is connected with it. A sensors' pole is installed with—at most, six groups of sensors, so that the taut wires' plane of the fence might include several “Sensing Slices”. Dividing the height of the pole into a number of “Sensing Slices” enables to run separately an analysis of the received signals from each of the sensors' groups, and in a manner that imparts high capability of identifying an intrusion attempt by climbing on the wires of the fence (for example—indication in a configuration of a continuum of signals from several “Sensing Slices” that are positioned one on the top of the other, and that are received successively, one after the other.

However, the sensors' pole in a DTR fence and the sensors that are installed on it, do not provide signals that enable to identify the exact location in space of the intrusion occurrence as it is related relative to the sensors' pole proper (for example—whether the intrusion attempt that is made by climbing on the fence, as we stated above, is taking place in the taut wires plane positioned to the right of the sensors' pole, or whether it occurs to the left of that sensors' pole).

Moreover, each one of the sensor groups by itself does not enable analyzing the group's produced signals at the specific individual sensor level, because the connection of the sensors in each group is done in series. In other words—the warning that is received relates to a given group of sensors and there exists no capability of discerning which is the single specific sensor that triggers the alarm within a given group.

The sensors that are installed nowadays in a DTR fence are of the “short/cut-off” binary sensors type (bi-state: go/no go). A variation in the tension of whichever wire it is from the couple (two) wires unto which the sensor in the DTR fence is connected, might extract the sensor from the state that it is regularly found in (for our presentation—shorted) and pass it to other state—namely cut-off, in a manner so that the control system that is all the while sampling the status of the sensors, might identify only the fact of the occurrence of an intrusion attempt through the fence, via the specific group of sensors.

A variation in the tension of a taut wire that, as said, brings about a change of state in a sensor (from short circuit to cut-off) is the outcome of actuating a certain weight on the wire unto which that sensor is connected (except in the case of severing (cutting) the wire). In other words, the sensor changes its status at the time that a wire unto which it is connected is biased beyond a given weight threshold. The level of sensitivity of the sensor is constant (in accordance to the weight unto which the wire is exposed and wherein it is sufficient for switching over the sensor from short circuit state to cut-off).

Thus, the sensors that are installed nowadays in a DTR fence, do not provide (issue) signals that enable to deduce information regarding the value (magnitude) of the weight that is operating on the wire before an alarm is sounded (before the switching over from a short (circuit) state to cut-off), and afterwards (following the sensor's switched from short (circuit) state to cut-off).

The sensors that are installed nowadays in a DTR fence also do not provide indications from which it might have been possible to estimate the way travelled by the wire that was subjected to the variation of the tension, nor the direction of this way in space. At most, it is possible to estimate that the switching over of the sensor from short circuit state to cut-off, is the outcome of the biasing of the wire and its bending in the plane of the wires, to within a shift of approximately 10 to 12 cm in a vertical direction (relative to the ground).

As for the sensors, that are as said binary (by-state) “switching over sensors” from short-circuit to cut-off, the sensors that are nowadays installed in a DTR fence are also not able to identify occurrences of appearance of vibrations in the wires, but only the occurrence of a steady pulling action on the wire as it happens due to biasing the wire unto a certain weight (except if it is considered to be cutting the wire).

However, to intrusion efforts through such taut wires fences, there might be accompanying occurrences of vibrations in the wires that do not rise (increase) up to an occurrence of a steady pulling force on the wire (for example, an intrusion act by setting a kind of a rigid frame (window like) on the wires of the fence, thus maintaining their tautness—and=as its second stage—cutting the wires that are found inside this frame).

It is important to note, that also the substantial physical size (dimensions) of the sensors that are installed nowadays in the DTR fences, constitute a limitation because it does not enable to deploy them at a beneficial crowded arrangement of taut wires such that variations of tautness on all of them would be amenable to be sensed.

Thus, before the invention that is the subject matter of this application, when using intrusion detection fences of the taut wire genre, it was not feasible to obtain the desired combination of beneficial indications—

Both for the location wherein the intrusion attempt occurs in relation to the sensor (does it occur to its right or rather to its left); determining the specific sensor producing the alarm from the group of sensors to which it belongs, and, as was said—in a dynamic mode and for prolonged time spans—applying to the varying weight unto which the wire is biased during the time of the intrusion attempt, its direction in space and the way that the wire goes through during the attempted intrusion; as well as indications concerning vibrations appearances unto which the wire might be exposed as a result of the intrusion attempt through it.

An additional drawback, due to the (relatively) large physical dimensions of the sensors, there exists in the intrusion detection fences of the taut wire fence type. A geometrical and packaging constraint (imitation) from the aspect of the capability of crowded deployment of taut wires with complete utilization of their capability to serve simultaneously—all of them, as an active “communication lines”, transferring indications regarding the occurrences of intrusion attempts through them to the sensors that are connected to them.

### SUMMARY OF THE INVENTION

The invention, the subject matter of this application, is expressed by implementing a compact, tri-axes accelerometer as a sensor to an intrusion detection taut wire fence, and this—by installing the sensor in relation to the plane of the taut wires, so that it is inclined at least in relation to the fence's taut wires plan and to the length dimension of the taut wire unto which the accelerometer is allocated and linking the accelerometer when it is inclined as said, to the taut wire to which it is allocated, by a mechanical means that from the instant (time) of biasing the taut wire (as happens at the time of an attempted penetration through it occurred), would convert the shift (movement) of the wire into a rotational movement of the sensor, wherein it can be sensed in all of the accelerometer three axes.

As per one aspect of the present invention, there is embodied in an intrusion detection fence of the taut wire fence type, that usually includes a couple of anchoring poles that are positioned at a certain distance one from the other, wires that are stretched taut between the two anchoring poles, at least one sensors' pole that is positioned between said two a anchoring poles and at least one sensor that is installed on the sensors' pole and connected at least to one of the taut wires for sensing such phenomenon that accompanies the intrusion attempt through the fence. Such a well-known taut wire fence, that in accordance with the invention is characterized by that the sensor is a tri-axes accelerometer that is installed on the sensors pole, wherein it is inclined in relation to the taut wire unto which it is connected, and, in addition—the sensor is connected to the taut wire by a means that from the instance (time) of biasing the taut wire (as happens at the time of an attempt intrusion through it occurred), would convert the shift (movement) of the wire into a rotational movement of the sensor, wherein it can be sensed in all of the accelerometer three axes.

As per a second aspect of the present invention, it is embodied in a sensing assembly with a tri-axes accelerometer for being used as a sensor to an intrusion detection fence of the taut wire type. An assembly that comprises a base means for installing the sensing assembly on a sensors' pole in a manner that the accelerometer would be installed so that it is inclined in relation to the taut wire unto which it is allocated, and a movement converting means that from the instance (time) of biasing the taut wire (as happens at the time of an attempted intrusion through it occurred), would convert the shift (movement) of the wire into a rotational movement of the sensor, wherein it can be sensed in all of the accelerometer three axes.

In a third aspect of the present invention, it is embodied as a generic method for sensing attempted intrusions through intrusion detection fences of the taut wire fence type, a method that comprises the steps of connecting a tri-axes accelerometer unto a taut wire of the fence, positioning the accelerometer wherein it is inclined relative to the taut wire of the fence unto which it is connected and converting the shift (movement) of the wire into a rotational movement of the accelerometer wherein it can be sensed in all of the accelerometer three axes.

### BRIEF DESCRIPTION OF THE ACCOMPANYING FIGURES

The present invention will be described herein in conjunction with the accompanying figures. Identical components, wherein some of them are presented in the same figure—or in case that a same component appears in several figures, will carry an identical number.

FIG. 1 constitutes a schematic view in perspective of an example of a typical segment of an intrusion detection fence of the taut wire type, in accordance with the invention.

FIG. 2 constitutes a close-up view of the sensor' pole in the fence that is illustrated in FIG. 1.

FIG. 3 constitutes a close-up view of a sensing assembly that is installed in the sensors' pole that is illustrated in FIG. 2.

FIG. 4 constitutes an exploded view of the components of the sensing assembly that is illustrated in FIG. 3.

FIG. 5 constitutes a front view of an example of a sensing assembly in accordance with the invention when it is found (maintained) at its “paused” state.

FIG. 6 constitutes a front view of an example of a sensing assembly in accordance with the invention that is the illustrated in FIG. 5, wherein the assembly is at its operating state—from the instance of biasing the taut wire as it occurs at a time of an intrusion attempt through it and converting the wire's movement into a rotational movement of the accelerometer that is amenable to be sensed in all its three axes.

FIG. 7 constitutes a schematic illustration of the positioning characteristic of the accelerometer wherein it is inclined relative to the taut wire unto which it is connected, wherein—in the illustrated figure, the accelerometer is inclined in all his three axes.

FIG. 8 constitutes a flow chart of an example of an algorithm for processing signals that are received from a sensing assembly in accordance with the invention.

### DETAILED DESCRIPTION OF A PREFERRED EMBODIMENT OF THE INVENTION

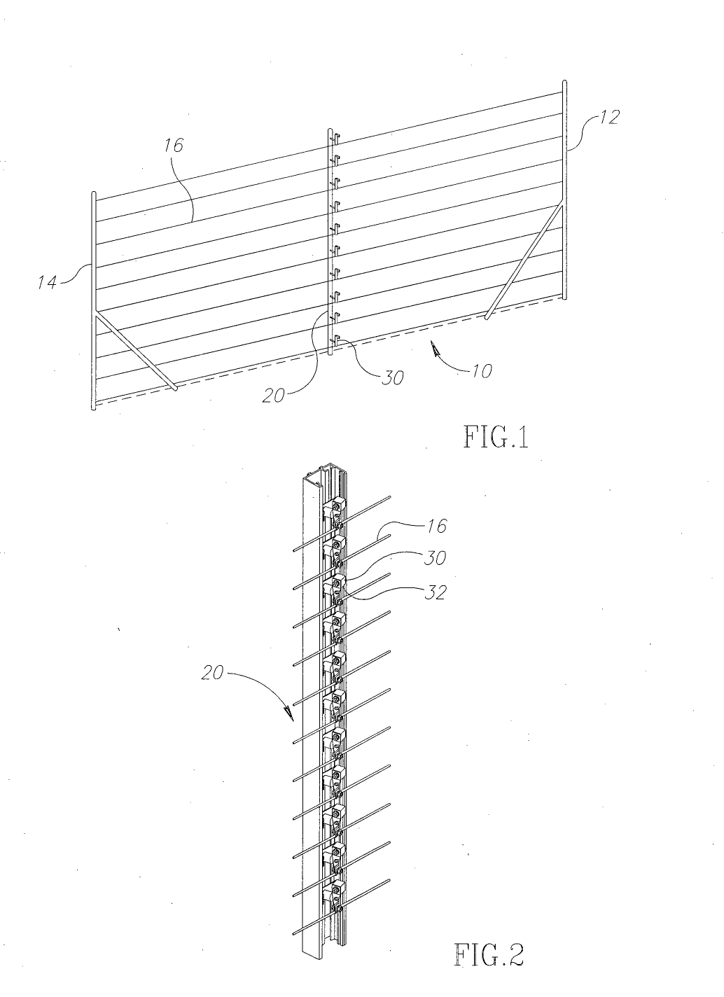

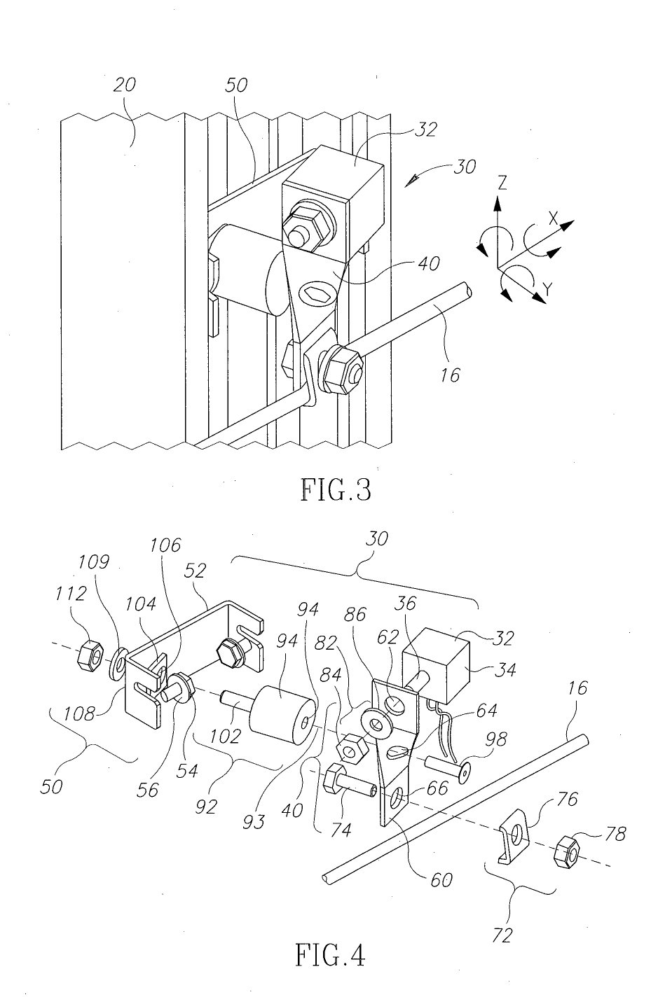

Reference is being made to FIG. 1 to FIG. 3. FIG. 1 constitutes a schematic view in perspective of a typical segment of an intrusion detection fence 10 in accordance with the invention. FIG. 2 constitutes a close-up view of the sensor' pole 20 of fence 10 that is illustrated in FIG. 1. FIG. 3 constitutes a close-up view of a sensing assembly 30 that is installed in the sensors' pole 20.

Any professional would understand that intrusion detection fence 10 is a taut wire fence that comprises recognized and known components—a couple of anchoring poles 12, 14 at a distance one from the other, wires 16 that are stretched taut between the couple of anchoring poles 12, 14, at a distance one from the other, sensors' pole 20 that is located between the couple of anchoring poles 12, 14, and a plurality of sensing assemblies 30 that are installed on sensors' pole 20, and—in the illustrated example, each one of them is linked in to one of the stretched taut wires 16 for sensing phenomena that are accompanying an intrusion attempt through fence 10

Any professional would also understand that there might exist other (i.e., different) configurations of a segment of the fence, for example—there might be installed several poles carrying sensors between a given pair (couple) of anchoring poles or that any of the sensing assemblies would be linked to more then one single taut wire (directly or through a common actuator), sliding poles (for example—in a spiral like shape) —might also be positioned between the pair of anchoring poles and part of the wires of the fence might be there solely as a physical barrier (namely might be devoid of any link to sensing assembly).

In any case, intrusion detection fence 10 is characterized by that in each of the sensing assemblies 30 there is installed a sensor 32 that is of the tri-axes accelerometer type, that is installed wherein it is inclined relative to a wire 16 unto which it is connected.

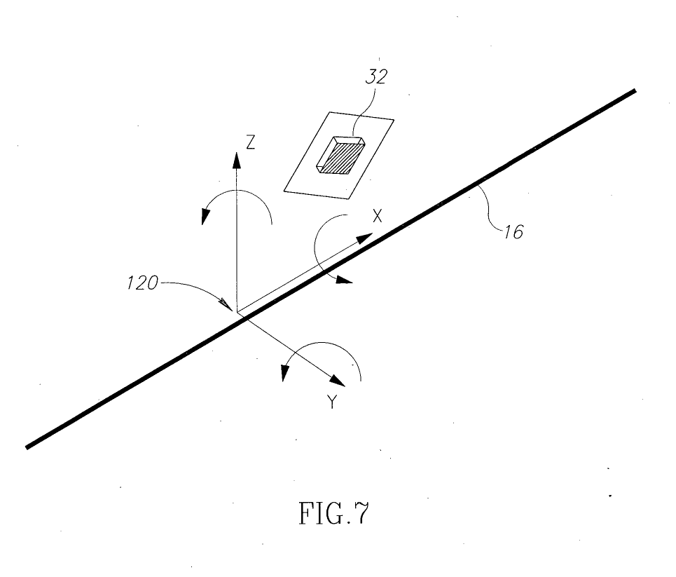

In a preferred configuration of the invention, the tri-axes accelerometer is installed wherein it is inclined in the spatial position in all its three axes relatively to the taut wire to which it is connected (namely it is inclined in comparison to the tri dimensional axes system in spatial position, where in it is defined by the lengthwise axis of the taut wire unto which it is linked, the axis that is perpendicular to the fence's taut wires plane and to the axis that is parallel to the plane of the taut wires of the fence. See further below when referring to FIG. 7).

An example of a feasible implementation to such a sensor, might be an Analog Devices ADXL 327 (see the specification at the following cite: http://www.analog.com/en/sensors/inertial-sensors/adxl327/products/product.html) in conjunction with an evaluation board of an Analog Devices EVAL-ADXL327Z unit (its specification is given in the data sheet found in: http://www.datasheetpro.com/1143147_download_ADXL327_datasheet.html), but any professional would understand that also other and different types of tri-axes accelerometers might be suitable for accomplishing the required operation.

Accelerometer 32 that is installed in sensing assembly 30 is connected to wire 16 by a movement converting means 40.

Sensing assembly 30 includes in addition also base means 50 for installing assembly 30 on the sensors' pole 20 of the fence, in a manner that accelerometer 32 would be installed in the spatial position, wherein—in accordance with a preferred configuration of the invention, it is installed so that it is inclined on all its three axes relative to the taut wire 16 unto which it is allocated.

Let's refer to FIG. 4. FIG. 4 constitutes an illustrated exploded view of the components of sensing assembly 30.

Sensing assembly 30 comprises as said an accelerometer 32 that in the illustrated example is packaged within housing assembly 34, whose—from its end, there protrudes a threaded rod 36. Any professional would understand that housing assembly 34 enables sealed packaging (for example inside an epoxy casting) of the accelerometer.

Sensing assembly 30 includes as said, base means 50. In the illustrated example, base means 50 includes component 52 of a rather U-shaped form, wherein any professional would understand that it might be formed from tin by bending. Component 52 is suited to be installed on sensors' pole 20 by an array (assembly) of two screws 54 and discs 56.

Sensing assembly 30, as said, includes also the movement converting means 40. Movement converting means 40 includes a component 60 that is formed as a twisting (winding) stripe with two ends and (with) a central segment. In the illustrated example, the presented subject is some kind of a twisting element that—as any professional would understand, may be formed from tin by bending. Component 60 is formed with bores 62, 64 and 66 (respectively) at its two ends and at its central segment.

Movement converting means 40 includes in addition means 72 that serves for connecting (linking) one end of twisting stripe 60 to taut wire 16. In the illustrated example, we are treating an array (assembly) of a screw 74, tightening discs 76 and a nut 78, that enables harnessing taut wire 16 to twisting stripe 60 (via bore 66).

Movement converting means 40 includes in addition, also a means 82 for anchoring accelerometer 32 at the other end of twisting stripe 60. In the illustrated example, the treated subject is the nut 84 and disc 86 array, that enables harnessing housing assembly 34 to twisting stripe 60 (using threaded pole 36 that is suited to pass through bore 62 and to be tightened on its other end).

Moreover, movement converting means 40 includes in addition also a springy axis means 92 that defines an axis 93—and in the illustrated example, it includes elastomeric component 94 that is formed around axis 93.

One end of springy axis means 92 is suited to be affixed unto the central segment of twisting stripe 60. In the illustrated example, by a threaded bore 96 that is formed on one end and that is suited for threading screw 98 into it via bore 64, and thus bring about a tightening of the central segment of twisted stripe 60 unto the springy axis 92, in a manner wherein rotational movement of the twisting stripe component 60 is enabled around axis 93.

The other end of springy axis means 92 is suited to be affixed to base means 50. In the illustrated example, springy axis means 92 is suited as said, to be affixed unto base means 50, via threaded rod 102 that is formed projecting from the other end of springy axis means 92. Threaded rod 102 is suited to pass through an angular directing means 104 (in the illustrated example—a small bent tin piece). Angular directing means 104 is adapted to be supported by U-shaped formed component 52 and formed with through-pass bore 106. Threaded rod component 101 is adapted in its dimensions to continue and pass also through pass-through bore 108 (not shown in the illustrated figure) that is formed in component 52 and to be tightened on its both sides by the disk 109 and nut 112 array.

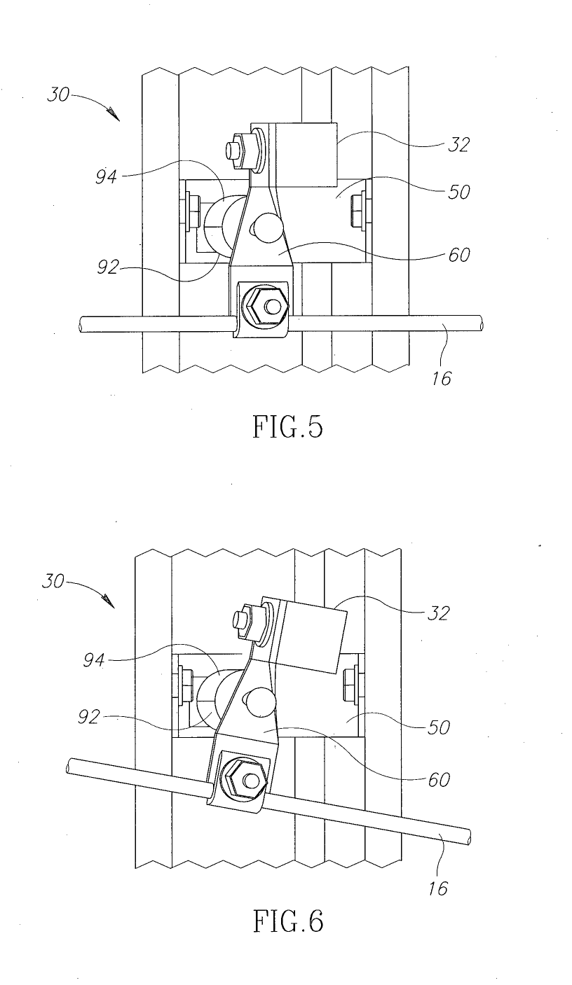

Reference is being made to FIG. 5 and FIG. 6. FIG. 5 constitutes a front view of an example of a sensing assembly 30 in accordance with the invention wherein it is found (maintained) at its “paused” state. FIG. 6 constitutes a front view of an example of same sensing assembly 30, wherein the assembly is at its operating state—from the instance of biasing taut wire 16 as it occurs at a time of an intrusion attempt through it and converting the wire's movement into a rotational movement of accelerometer 32, that is amenable to be sensed in all its three axes.

At its “paused” state, accelerometer 32 would be installed in a spatial position, wherein in accordance with the preferred configuration of the invention—accelerometer 32 is inclined in its entire three axes relative to taut wire 16 unto which it is connected. This implementation in spatial position is obtained by forming twisting stripe 60 in a manner that one of its ends is connected, as said, to taut wire 16, whereas accelerometer 32 is anchored to twisting stripe 60 other side, which is twisted in its direction relative to said twisting stripe 60 first end, and in combination that defines the rotation axis of twisting stripe 60, perpendicular to another and additional plane of twisting stripe 60 (the plane of the central intermediate segment of twisting stripe 60) and this—by springy axis means 92 and base means 50.

In the operating stage, from the instance (time) of biasing taut wire 16 (as it happens at the time of an attempted intrusion through it occurred), movement converting means 40 would convert the shift (movement) of wire 16 into a rotational movement of accelerometer 32, wherein it can be sensed in all of its three axes. The rotational movement is performed around axis 93 of springy axis means 92 (see FIG. 4), wherein from the instance that the taut wire moves, elastomeric component 94 instills a springy operation unto means 92 in a manner that upon termination of the movement, movement converting means 40 will revert to its original “paused” state.

Let's refer to FIG. 7.

FIG. 7 constitutes a schematic illustration of the positioning characteristic of accelerometer 32 wherein by the preferred configuration of the invention, it is inclined in its entire three axes relative to the taut wire 16 unto which it is connected.

The implementation—in accordance with the invention, of an accelerometer as a sensing means, enables to obtain a unique electric signal for every occurrence of touching the taut wire (namely—pulling, vibration, movement and passing through it). Furthermore, because the subject discussed is an accelerometer that is a tri-axes type, the tri-axes accelerometer would generate three electric voltages as per its three axes in accordance with the initial location of the accelerometer and these signals can be sampled by a signal processing unit and furthermore store them and keep them in a voltages calibration table. A passage of the accelerometer from its initial position in a spatial position to another position would lead to producing different voltages in the three axes (enabling to compare them to the voltages that were measured at their initial locations).

Hence, any professional would understand that a prominent characterizing feature of the invention is the installation of a tri-axis accelerometer wherein it is installed so that it is inclined relative to the taut wire unto which it is connected, and in a preferred embodiment (configuration) of the invention the accelerometer is already installed wherein it is inclined in a spatial position in all its three axes.

In other words—on referring to the three dimensional Cartesian system of axes 120, wherein its origin (of the axes) is defined by a taut wire 16 and the plane in which the wires of the fence are deployed, namely—X axis along the taut wire, Y axis perpendicular to the plane constituting the taut wires fence and the Z axis in parallel to the plane of the deployed taut wires fence, biasing taut wire 16, as happens when an attempted intrusion (or an act of harming the fence) occur, would lead to said rotational movement of the accelerometer, a rotational movement that would be amenable to being sensed in all the three axes of the accelerometer.

Even in a case of a typical intrusion attempt, such as climbing on the taut wires fence or breaking them apart, in a manner that naturally is accompanied with biasing the taut wire to be bent downwards (direction of the ground), namely—in a way that leads to bi-directional biasing of the taut wire along its length (X axis) and downwards (Z axis) —then the position in the spatial position of the try-axes accelerometer would, in accordance with the invention, subject the accelerometer to a rotational movement in a manner that it will be possible to receive signals from all its three axes.

The spatial positioning of the accelerometer and the resulting rotational movement from the instance of an attempted penetration through the taut wire to which it is connected (in a manner that it would produce (generate) signals from all its three axes), were described above and when referring to the accompanying figures, for one implementation example. Any professional would understand that the above mentioned functions might be obtained also by other and different means (for example—movement converting means that are not in the configuration of a bent stripe but, say, formed by casting, springy means that is based on a leaf spring item, spiral spring or discs that are also springy and not depending on an elastomeric component as described above, different systems (arrays) for anchoring, additional means for sealing and protecting the sensing assembly).

Any professional would also appreciate the fact that in the invention there is embodied a generic method for sensing attempted intrusion acts through a taut wires intrusion detection fence. It is a general method that comprises the steps of connecting a tri-axes accelerometer to a tout wire of the fence (in the example described above while referring to the accompanying figures—linking accelerometer 32 to taut wire 16). An additional step in this method is the positioning of the accelerometer so that it is spatially inclined relative to the taut wire of the fence unto which it is connected (in the cited example, position accelerometer 32 as it is spatially inclined relative to taut wire 16—and see FIG. 7). At its final step the method implements the step of converting the movement of the taut wire—as it occurs when there is an intrusion attempt through it, into a rotational movement of the accelerometer that is amenable to being sensed at all the accelerometer's three axes (in the cited example, converting the movement of taut wire 16 to a movement of accelerometer 32 that is rotational relative to the three dimensional Cartesian system 120 whose origin is defined by taut wire 16 and the plane of the taut wires fence in which it participates (see FIG. 7), and in a manner wherein it is amenable to being sensed in all the three axes of accelerometer 32). In a preferred version of the method, the spatial positioning of the accelerometer is providing in advance for the accelerometer inclination in all its three axes.

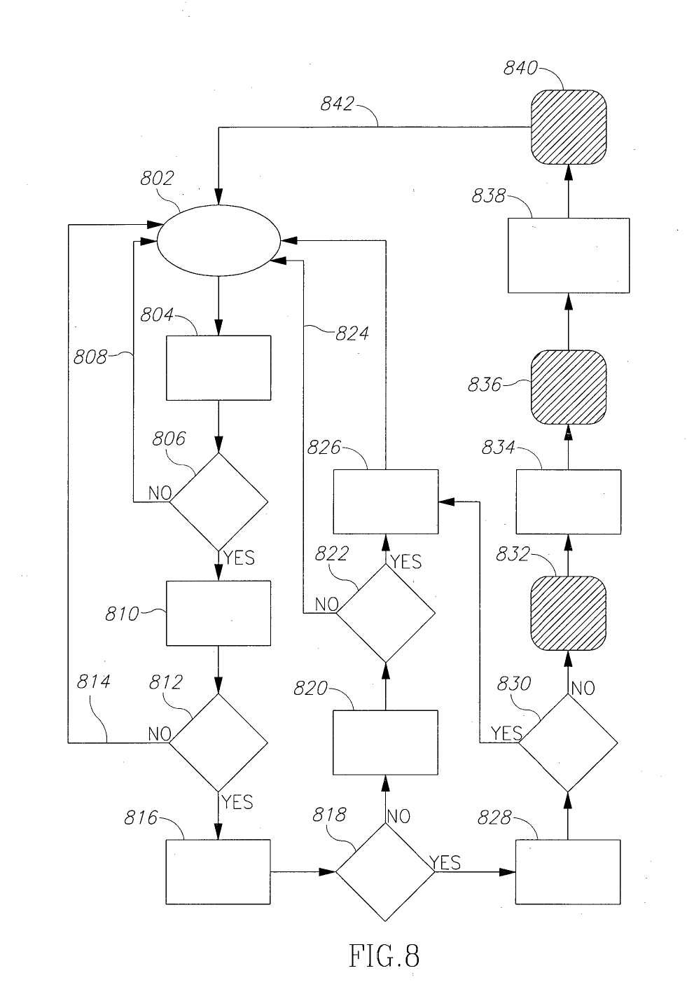

Reference is being made to FIG. 8. FIG. 8 constitutes a flow chart of an example of an algorithm for processing signals that are received from sensing assembly 30. For reasons of convenience, the algorithm is described hereinafter by referring to signals that are received from only one axis from the existing three axes of the accelerometer, but any professional will appreciate the fact that such algorithms with slight well-known modifications are implementable for analyzing three signals in parallel.

Following initial stage 802, step 804—the measurement of the voltage level of the signal, is performed.

In the next stage—806, comparison of the voltage level to the level of a pre-set constant threshold is executed. If the level is lower than the threshold, a return (808) to the initial stage 802 is executed. If the level of the signal is higher than the threshold, stage 810 of measuring the signal's time width is executed.

In the next stage—812, comparison of the signal's time width to a pre-set constant threshold is executed. If the signal's time width is lower than the threshold, a return (814) to the initial stage 802 is executed. If the signal's time width is wider than the threshold, stage 816 of counting signals is executed.

In the next stage—818, there is performed a comparison of summing the number of signals that were counted to a pre-set constant threshold.

If the quantity of signals that were counted is lower than the threshold, stage 820 is executed—namely a measurement of the “time window” in which “a number of signals” was received. In the next stage—822, a comparison of the time window to the number of signals counted to a pre-set constant threshold is taking place. If the time window that was measured for a number of signals is shorter from the constant threshold, there is still concern for a warning and hence a return 824 to the initial stage 802 occurs. If the measured time window that was measured for a number of signals (as before) is longer than the constant threshold, the subject matter encountered is a slow phenomena that does not raise concern and thus stage 826 of zeroing (calibrating) the signal for warning (i.e., the signal is not being reckoned in the calculation of the number of signals), and hence return to the initial stage 802 is performed.

On the other hand, if at the cited stage 818, the comparison of the summation of the number of signals that were measured to a constant threshold points on a substantial and higher than the threshold amount, stage 828 is executed, wherein it is (similar to stage 820) a measuring of the time window in which the signals were received. In the next stage—830, there is also executed (similar to stage 820) a comparison of the time window that was measured to the constant threshold. If the time window that was measured is longer than the constant threshold, the subject matter encountered is a slow phenomena that does not raise concern and thus stage 826 of zeroing (calibrating) the signal for warning (i.e., the signal is not being reckoned in the calculation of the number of signals) is taking place, and hence return to the initial stage 802 is performed.

However, if the time window that was measured is smaller than the pre-set constant threshold—it indicates that there might be an intrusion warning.

From the instance that a warning is impeding, a continuum of warnings and processing starts—

In stage 832 an intensity warning is issued. In an intrusion detection fence in accordance with the invention, variations of tautness that occurred in the taut wire change the voltage levels that are received from the tri-axes accelerometer (in every one of its axes). The time in which the change of the voltage occurred is equivalent to the time span during which the change in the tautness of the fence taut wire occurred. In addition, in an intrusion detection fence in accordance with the invention, the number of signals (i.e., the electrical pulses) that the accelerometer generates (produces) in each one of its three axes—and this due to the occurrence of vibrations in the taut wires, might be in the range from a single pulse to tens of pulses. The intensity of the pulse varies and depends on the measure of tautness in the taut wire and the intensity of the vibration phenomena that occurs in the taut wire (wherein a constant variation in the tautness of the wire would cause the production of a single, constant pulse). Hence, in the algorithm that we pointed at above, (before arriving at stage 832), measurements were conducted of the intensity (value) of the voltage and of the width in time of the pulses that were produced as a result of touching the wire or due to the vibrations of the taut wire. In accordance with the (constant) pre-set thresholds that were defined above regarding the intensity of the voltage, width of time of the pulse, quantity of the pulses and the size (magnitude) of the window in time, the algorithm determines whether it is a true warning or a false one.

In stage 834 a measurement of the polarity of the signals is executed. In an intrusion detection fence in accordance with the invention, variations of the tautness that occurred in the taut wire either right or left to the location of the accelerometer cause change of the polarity (positive or negative) of the voltage at the point of sampling. Hence, it is possible to determine the impact side in which the intrusion attempt occurred (namely the biasing of the wire) in reference to the accelerometer position and in stage 836 a directional warning is given (e.g. —right or left to the accelerometer).

In stage 838 a multiplication of the levels of the voltages of the signals that were received by the square time width is performed. In an intrusion detection fence in accordance with the invention, the acceleration of the accelerometer is proportional to the voltage, thus when the capability to measure the time of the occurrence is given, it is possible to calculate the taut wire movement. Considering the aspects of the rigidity of the wires, it is possible to estimate the measure of bending of the wire and the opening formed accordingly, and, in stage 840- to add also a warning about the geometrical size of the break in.

In stage 842 the system reverts to the initial state 802.

Any professional would understand that the algorithm that was described above is solely one example from many of algorithms that can be implemented for the sake of processing the information that is received from a sensing assembly in accordance with the invention.

This and more—in an intrusion detection fence in accordance with the invention, it is possible to receive simultaneously and in parallel, to one (single) processing unit, signals from several accelerometers. Any professional would understand that when the accelerometers are not connected in series to the processing unit but rather in parallel, and when given the logical statistical fact that it is possible to locate time spans in which one accelerometer produces a signal whereas the others do not produce signals, and vice versa (and this even though the taut wires that are connected with them are biased at the same time due to the intrusion attempt), then it is possible to receive, for an extended period, the signals from a plurality of accelerometers in parallel to one signal processing unit and to receive a specific warning regarding to each one of them—separately.

Thus, subject to what was described above while referring to the accompanying figures, any professional would appreciate the fact that rather important advantages that are not obtained nowadays from an intrusion detection of the taut wires type (e.g. —those we pointed at above in the “background of the invention” section) might be enabled as an outcome of the innovative implementation of a compact, tri-axes accelerometer serving as the sensor for the intrusion detection fence of the taut wire type—and this through a spatial installation of the sensor relative to the plane of the taut wires, namely—wherein it is inclined in relation to the plane of the taut wires, and connecting it spatially inclined as said, unto the taut wire to which it is allocated, by a mechanical means that from the instance of biasing the taut wire (as occurs at a time of an attempted break-in through it) as said, will convert the motion of the wire to a rotational movement of the accelerometer, that is amenable to be sensed in all its three axes.

Implementing the invention would enable to produce combined indications that are highly beneficial but unobtainable from known (existing) taut wire fences. Both in relation to the position (location) of the occurrence of the attempted intrusion in relation to the accelerometer (does it happen to the right of the sensor or on its left); as well as for identifying the specific (individual) accelerometer that warns—from among the group of sensors to which it belongs (for example—a group of sensors that is installed on a sensors' pole wherein it is connected to the processing unit in parallel); as well as in a dynamic manner and for prolonged times—regarding the varying weight unto which the wire is biased during the time of the attempted break-in, its direction in spatial position and even estimating the geometrical path the wire traverses at the time that an intrusion through it is tried; and as well as also indications regarding instances of vibrations unto which the wire might be exposed due to the intrusion act through it.

Moreover, in view of the physical compactness of a sensor of the tri-axes accelerometer type, the implementation of the invention enables a crowded (tightly packed) deployment of taut wires while fully exhausting the ability to use—all of them—as “communication lines” (venues) that are active—all of them and simultaneously, for transferring indications regarding the occurrence of a penetration effort through them. In other words—sensors of the tri-axes accelerometer type in accordance with the invention, that are relatively small in their dimensions, enable positioning a large number of sensors along the sensors' pole, and accordingly receiving indications from a large number of wires in the fence.

Any professional would understand that the present invention was described above only in a way of presenting examples, serving our descriptive needs and those changes or variants in the structure of the means that constitute a taut wire type of intrusion detection fence—which is the subject matter of the present invention, hence they would not be excluded from the framework of the invention.

In other words, it is feasible to implement the invention as it was described above while referring to the accompanying figures, also with introducing changes and additions that would not depart from the constructional characteristics of the invention, characteristics that are claimed herein under.

1. An intrusion detection fence of a taut wires type that comprises—
a couple of anchoring poles that are positioned at a distance one from another; and—
wires that are stretched taut between said two anchoring poles; and—
at least one sensors' pole that is located between said anchoring poles; and—
at least one sensor that is installed on said sensors' pole and that is linked with at least one of said taut wires for sensing phenomena that accompanies an attempted intrusion through said fence; and—
wherein said intrusion detection fence is characterized by that—
said sensor is a tri-axes accelerometer that is installed on said sensors' pole wherein it is inclined relative to said taut wire unto which it is connected; and—
said sensor is connected to said taut wire via a movement converting means such that from an instance of biasing said taut wire as happens when an intrusion attempt through it occurs, converts a movement of said taut wire unto a rotational movement of said sensor that is amenable to be sensed in all of its three axes.

2. An intrusion detection fence in accordance with claim 1, wherein said sensor is inclined in a spatial position relative to said taut wire unto which it is connected, and this in each and every one of its three axes.

3. An intrusion detection fence in accordance with claim 1, wherein said movement converting means comprises—
a component that is formed as a twisting stripe with two ends and with a central segment; and—
connecting means for connecting said twisting stripe component to said taut wire; and—
anchoring means for anchoring said sensor on said second end of said twisting stripe component; and—
a springy axis means whose one end is installed on said central segment of said twisting stripe, and its other end is linked to said sensors' pole; and—
wherein said rotational movement of said sensor, as it occurs from an instance of movement of said taut wire, is taking place around said springy axis means.

4. An intrusion detection fence in accordance with claim 3, wherein said springy axis means comprises—
an elastomeric component that instills springy action to said means, from said instance of movement of said taut wire.

5. A sensing assembly with a tri-axes accelerometer type sensor, to be used as a sensor in an intrusion detection fence of the taut wires type that comprises—
base means for installing said assembly on a sensor's pole of said fence in a manner so that said tri-axes accelerometer would be installed wherein it is inclined relative to the taut wire to which it is allocated; and—
movement converting means that from an instance said taut wire is biased as it happens on occurrence of an intrusion attempt through it, will convert the movement of said wire unto a rotational movement of said tri-axes accelerometer that is amenable to be sensed in all its three axes.

6. A sensing assembly with a tri-axes accelerometer type sensor in accordance with claim 5, wherein said tri-axes accelerometer is installed in a spatial position wherein it is inclined relative to said taut wire unto which it is allocated in all of its three axes.

7. A sensing assembly with a tri-axes accelerometer type sensor in accordance with claim 5, wherein said movement converting means comprises—
a component that is formed as a twisting stripe with two ends and with a central segment; and—
connecting means for connecting said twisting stripe component to said taut wire; and—
anchoring means for anchoring said sensor on said second end of said twisting stripe component; and—
a springy axis means whose one end is installed on said central segment of said twisting stripe, and its other end is linked to said sensors' pole; and—
wherein said rotational movement of said sensor, as it occurs from an instance of movement of said taut wire, is taking place around said springy axis means.

8. A sensing assembly with a tri-axes accelerometer type sensor in accordance with claim 7, wherein said springy axis means comprises—
an elastomeric component that instills springy action to said means, from said instance of movement of said taut wire.

9. A method for sensing intrusion attempts through a taut wires type of intrusion detection fence that comprises the steps of—
connecting a tri-axes accelerometer to a taut wire of a taut wires intrusion detection fence; and—
positioning said tri-axes accelerometer wherein it's inclined relative to said taut wire unto which it is connected; and—
converting movement of said taut wire as it occurs when an intrusion attempt is taking place through it unto a rotational movement of said tri-axes accelerometer type sensor that is amenable to be sensed in all of its three axes

10. A method for sensing attempts of intrusion through a taut wires type of intrusion detection fence in accordance with claim 9, wherein—
said positioning of said tri-axes accelerometer is mounted wherein it is inclined relative to said taut wire unto which it is connected, so that said accelerometer is inclined in space in all its three axes.
